(19) United States
(12) Patent Application Publication
(10) Pub. No.: US 2026/0121981 A1
(43) Pub. Date: Apr. 30, 2026

(54) ENHANCEMENT TO BGP DYNAMIC ROUTE AGGREGATION

(71) Applicant: Palo Alto Networks, Inc., Santa Clara, CA (US)

(72) Inventors: Enke Chen, San Jose, CA (US); Jining Tian, Saratoga, CA (US); Jennifer Yuan, San Ramon, CA (US)

(21) Appl. No.: 18/933,953

(22) Filed: Oct. 31, 2024

(51) Int. Cl. H04L 45/745; H04L 45/02

(52) U.S. Cl. CPC H04L 45/745; H04L 45/02

(57) ABSTRACT

The present application discloses a method, system, and computer system for routing network traffic. The method includes (i) receiving, at least indirectly from one or more contributor nodes, a set of route information, (ii) causing a routing table to be updated based at least in part on the indication, and (iii) routing network traffic based at least in part on the routing table. The route information obtained from a particular contributor node includes a network prefix, and one or more attributes. The one or more attributes comprises an indication of whether a particular aggregator node to which the route information is provided to be used as a primary aggregator node or a backup aggregator node.

### BACKGROUND OF THE INVENTION

Border Gateway Protocol (BGP) is a routing protocol that connects autonomous systems to the Internet via border network elements that interface with ingress and egress traffic between the autonomous systems and the Internet. Each autonomous system comprises network prefixes managed by an administrative entity, e.g., a border network element. Border network elements managing autonomous systems establish connections as peers in BGP. Network prefixes advertised between BGP peers can be appended with community attributes that specify handling of those network prefixes such as geographic-based advertisement restrictions, peer type restrictions, local preference adjustments, denial-of-service attack identification, etc. BGP peers are also able to associate network prefixes with extended community attributes for specifying additional information for the desired handling.

### BRIEF DESCRIPTION OF THE DRAWINGS

Various embodiments of the invention are disclosed in the following detailed description and the accompanying drawings.

FIG. 1 is a system diagram overview of an example cloud-based security service according to various embodiments.

FIG. 2A is a system diagram of an example cloud-based security service according to various embodiments.

FIG. 2B is another system diagram of an example cloud-based security service according to various embodiments.

FIG. 3 illustrates an embodiment of a network gateway according to various embodiments.

FIG. 4 is a functional diagram of logical components of an embodiment of a data appliance.

FIG. 5 is a block diagram of a network system according to various embodiments.

FIG. 6 is a block diagram of a route aggregation service.

FIG. 7 is a block diagram of a route aggregation service according to various embodiments.

FIG. 8A is an example of an extended community encoding according to various embodiments.

FIG. 8B is an example of an extended community encoding according to various embodiments

FIG. 9 is a flow diagram of a method for routing network traffic according to various embodiments.

FIG. 10 is a flow diagram of a method for providing route information according to various embodiments.

FIG. 11 is a flow diagram of a method for providing route information according to various embodiments.

FIG. 12 is a flow diagram of a method for advertising a route aggregation according to various embodiments.

FIG. 13 is a flow diagram of a method for determining a local preference value for a route aggregation according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A “prefix” or “network prefix” as used herein refers to a range of Internet Protocol (IP or IPv6) addresses defined by an IP address and corresponding subnet mask. For instance, 192.0.2.0/24 in Classless Inter-Domain Routing (CIDR) notation comprises a network prefix of all IP addresses for the IP address 192.0.2.0 with subnet mask 255.255.255.0 in dot-decimal notation. The phrase “encompassed by” in reference to network prefixes refers to a first network prefix whose range of IP addresses are included in the range of IP addresses of a second network prefix. To exemplify, if network prefix A is encompassed by network prefix B, then each IP address in the range of IP addresses for network prefix A is included in the range of IP addresses for network prefix B.

As used herein, an updated local preference value may comprise a local preference value adjusted based on an offset value. The adjustment to the local preference value may include subtracting the offset value from the local preference value to obtain the updated local preference value. In some embodiments, the updated local preference value is used to as the LOCAL_PREF value for the corresponding route advertisements.

U.S. patent application Ser. No. 17/961,252, filed on Oct. 6, 2022, titled ‘Deploying IPV6 Routing,’ is hereby incorporated by reference in its entirety for all purposes. The incorporation of this material serves to supplement and support the teachings and embodiments disclosed in this application, providing additional technical details, examples, and explanations that further enhance the understanding of the present invention.

U.S. patent application Ser. No. 18/359,978, filed on Jul. 27, 2023, titled ‘Border Gateway Protocol Dynamic Route Aggregation,’ is hereby incorporated by reference in its entirety for all purposes. The incorporation of this material serves to supplement and support the teachings and embodiments disclosed in this application, providing additional technical details, examples, and explanations that further enhance the understanding of the present invention.

Various embodiments provide a system and method for implementing BGP Dynamic Route Aggregation in which a partiuclar device provides more specific routes and acts as a “contributor” for route aggregation, and another device performs route aggregation and acts as an “aggregator”. The aggregation information (including the prefix length) can be specified and carried in the extended community attribute by the contributor. Techniques described herein provide a flexibility and simplification for deploying multiple “aggregators” in the “primary” or “secondary” roles, etc.

Various embodiments provide a method, system, and computer system for routing network traffic. The method includes (i) receiving, at least indirectly from one or more contributor nodes, a set of route information, (ii) causing a routing table to be updated based at least in part on an indication, and (iii) routing network traffic based at least in part on the routing table. The route information obtained from a particular contributor node includes a network prefix, and one or more attributes. The one or more attributes comprises an indication of whether a particular aggregator node to which the route information is provided to be used as a primary aggregator node or a backup aggregator node.

Various embodiments relate to dynamic route aggregation in communication networks, specifically, for example, in the context of Border Gateway Protocol (BGP) routing.

More particularly, various embodiments are directed to a method and system for distinguishing between a primary aggregator node and one or more backup aggregator nodes using an offset value, which enables dynamic adjustment of local preference values for route aggregation advertisements.

BGP is a fundamental protocol used to exchange routing information between Autonomous Systems (ASs) on the internet. In large-scale networks, multiple routes to the same destination often exist, and BGP relies on various attributes to select the best path. One such attribute is the local preference (LOCAL_PREF) value, which is used within an AS to influence the selection of outbound routes. The higher the LOCAL_PREF value associated with a route, the more preferred it becomes for forwarding traffic.

In networks employing route aggregation, a network node such as a router, referred to as an aggregator node, combines multiple specific routes into a summarized or aggregated route, which it then advertises to peers (e.g., BGP peers that are neighbors) such as neighboring routers. However, in scenarios where there are both primary and backup aggregator nodes, managing the preference of the routes they advertise is crucial to ensure that traffic is primarily routed through the primary aggregator node, with the backup aggregator nodes being used only when necessary (e.g., in case of failure or other unavailability of the primary aggregator node).

Current methods of managing route advertisements in such environments involve manually setting LOCAL_PREF values for the primary and backup aggregator nodes. However, this approach is static and can be inefficient, particularly in dynamic network environments where route changes occur frequently. Moreover, if the backup aggregator nodes advertise routes with the same LOCAL_PREF as the primary aggregator node, traffic could be sub-optimally distributed or lead to routing loops.

To address these issues, various embodiments implement a mechanism that allows a contributor node (e.g., a router that supplies specific routes to the aggregator nodes) to provide the same prefix to both primary aggregator node and one or more backup aggregator nodes, along with an offset value that is used by the aggregator nodes to dynamically adjust the LOCAL_PREF values for their route advertisements. This offset value distinguishes between the primary aggregator node and the one or more backup aggregator nodes by influencing the LOCAL_PREF in such a way that the primary aggregator advertises (e.g., always advertises) routes with a higher preference.

In some embodiments, the contributor node provides the same route prefixes to both the primary aggregator node and the backup aggregator node(s). The contributor node also provides an offset value (e.g., a value set by the contributor node) to each aggregator node. In some embodiments, the offset value for the primary aggregator is set to zero, and the offset value for each backup aggregator is non-zero (typically greater than zero). In some embodiments, the offset value to be provided to a backup aggregator node is higher than the offset value provided to the primary aggregator node. The aggregator nodes (e.g., the primary aggregator node and the backup aggregator node(s)) then use the offset value they respectively received to adjust the LOCAL_PREF for the routes they advertise. Specifically, in some embodiments, the aggregator nodes subtract the offset value from the LOCAL_PREF to obtain an updated LOCAL_PREF value.

For example, the primary aggregator node receives an offset value of zero, and the backup aggregator nodes receive offset values greater than zero. Both the primary and backup aggregators start with the same initial LOCAL_PREF value. The primary aggregator node, upon subtracting the offset value (e.g., which is zero in this example), retains the original LOCAL_PREF value, ensuring that its routes are advertised with a higher preference.

Conversely, the backup aggregator node(s) subtract their non-zero offset values from the LOCAL_PREF, resulting in a lower LOCAL_PREF for the routes they advertise. As a result, the routes advertised by the primary aggregator node will be preferred over those advertised by the backup nodes under normal operating conditions.

According to various embodiments, the system dynamically distinguishes between primary and backup aggregators without requiring manual intervention or static configuration changes. The approach ensures that traffic is routed through the primary aggregator during normal operation, with the backup aggregator nodes serving as failovers. In the event of a failure at the primary aggregator, traffic can automatically shift to the backup aggregators based on their lower, but still available, LOCAL_PREF values.

According to various embodiments, the system and method is particularly beneficial in large-scale networks with multiple aggregator nodes, improving the efficiency and reliability of BGP route aggregation and advertisement. The mechanism implemented by various embodiments also simplifies the management of route preferences by automating the process of adjusting LOCAL_PREF values based on dynamically provided offset values from the contributor node.

Accordingly, various embodiments provide an enhanced method for handling route aggregation in BGP by introducing the use of an offset value to distinguish between primary and backup aggregator nodes. This enables more efficient and dynamic route management while ensuring that traffic follows the most preferred path in normal conditions and seamlessly switches to backup routes during failures.

### Advanced or Next Generation Firewalls

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices, and in some implementations, certain operations can be implemented in special purpose hardware, such as an ASIC or FPGA).

Firewalls typically deny or permit network transmission based on a set of rules.

These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as described herein). A firewall can also filter local network (e.g., intranet) traffic by similarly applying a set of rules or policies.

Security devices (e.g., security appliances, security gateways, security services, and/or other security devices) can perform various security operations (e.g., firewall, anti-malware, intrusion prevention/detection, proxy, and/or other security functions), networking functions (e.g., routing, Quality of Service (QoS), workload balancing of network related resources, and/or other networking functions), and/or other security and/or networking related operations. For example, routing can be performed based on source information (e.g., IP address and port), destination information (e.g., IP address and port), and protocol information (e.g., layer-3 IP-based routing).

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks'PA Series firewalls).

For example, Palo Alto Networks' next generation firewalls enable enterprises to identify and control applications, users, and content-not just ports, IP addresses, and packets-using various identification technologies, such as the following: App-ID for accurate application identification, User-ID for user identification (e.g., by user or user group), and Content-ID for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

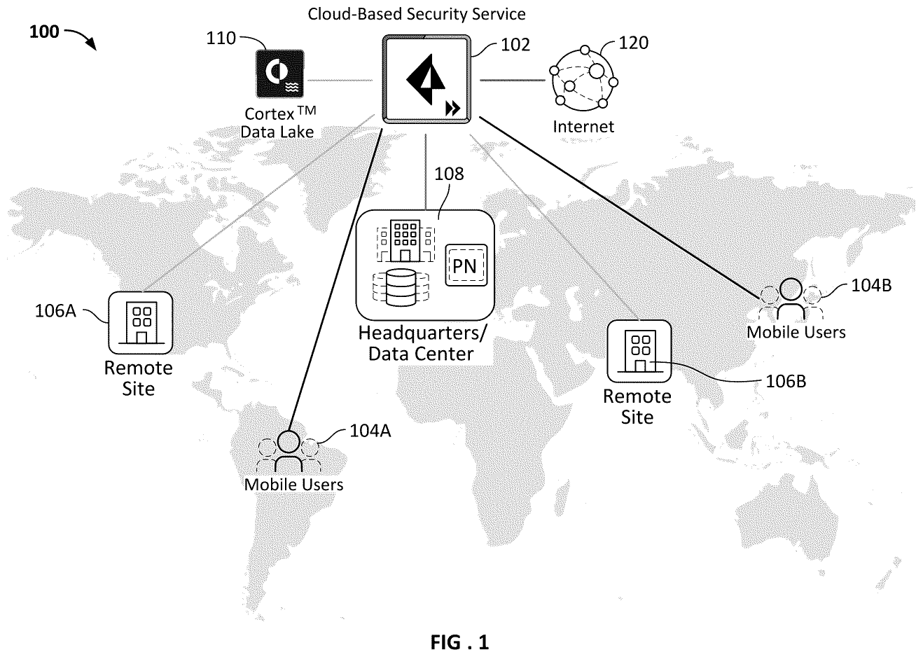

FIG. 1 is a system diagram overview of an example cloud-based security service in accordance with some embodiments. In this example cloud-based security service shown at 102, various mobile users 104A and 104B, remote sites 106A and 106B (e.g., to secure remote network locations, such as branch offices and remote networks, and users in those branches with cloud-based next-generation firewalls), as well as a headquarters/data center 108 of an enterprise customer(s) are in communication with the cloud-based security service. A data store 110 (e.g., a Cortex^{TM} Data Lake or another data store solution) is also in communication with the cloud-based security service for storing various logs and/or other information for the cloud-based security service.

For example, the cloud-based security service can provide various firewall, VPN (e.g., establishing IPsec tunnels using one or more IP address pools to allow the service to assign IP addresses for the client VPN tunnels to facilitate secure communication between, for example, internal resources in the customer's enterprise network, the enterprise customer's mobile users, and users in their remote network/site locations), and other security related services for the mobile users, remote sites, and headquarters/data center based on policies (e.g., security policies configurable by the enterprise customer), such as for secure access to web sites/services (e.g., including SaaS provider services) on the Internet shown at 120.

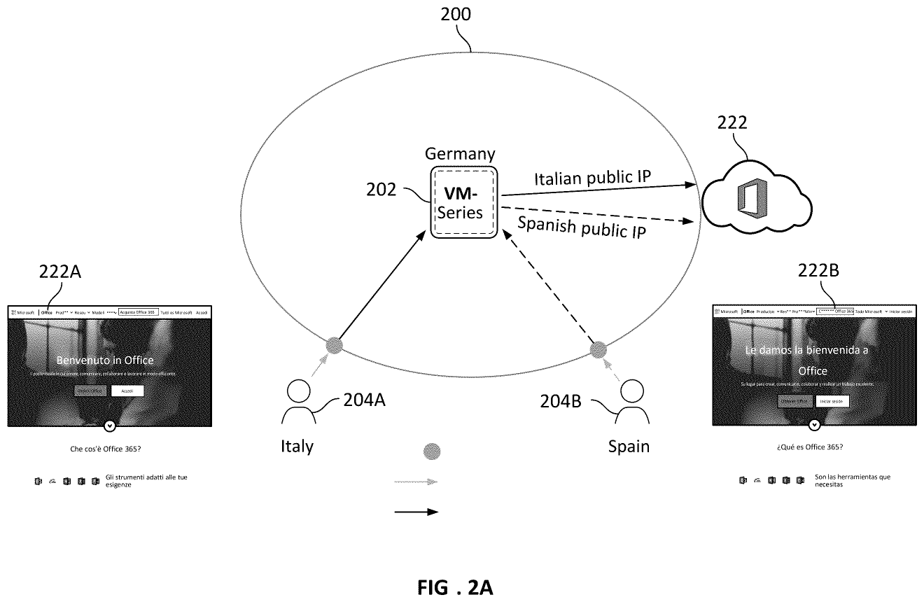

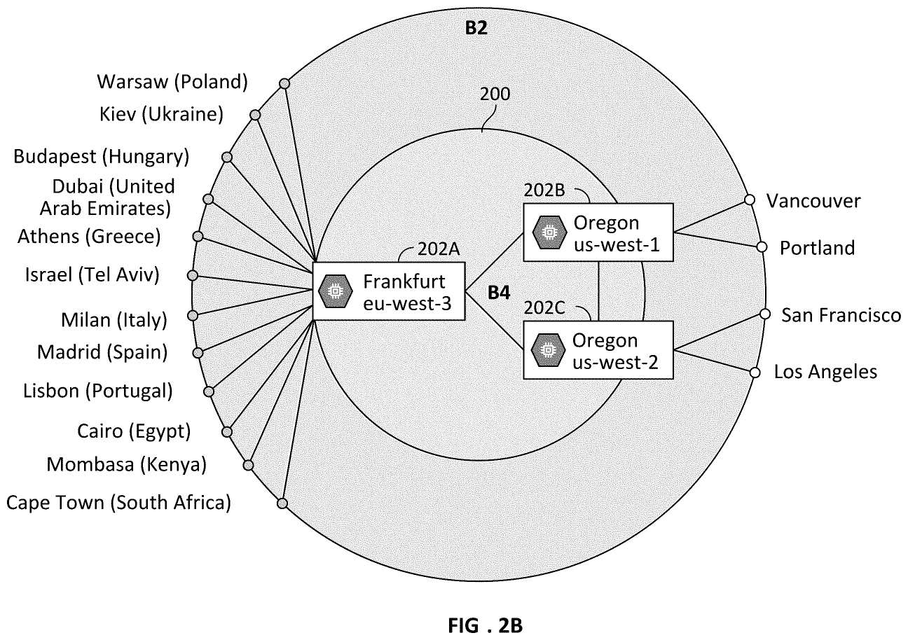

FIG. 2A is a system diagram of an example cloud-based security service in accordance with some embodiments. For example, a cloud-based security service 200 can be implemented using a commercially available public cloud solution, such as the Google Cloud Platform (GCP), to facilitate a low latency for supported SaaS providers (e.g., Microsoft Office 365® as shown and/or other supported SaaS providers, such as Salesforce®, etc.) as well as implementing the disclosed techniques for an enhanced local experience for users of the cloud-based security service when they are connecting to web sites/services on the Internet including such SaaS provider solutions available on the Internet. As will be apparent to one of ordinary skill in the art, the disclosed techniques can similarly be implemented using public cloud solutions that are commercially available from other public cloud service providers, a combination of various public cloud service providers, or also by using regional data centers maintained/controlled by the cloud-based security service provider, or any combination thereof.

Referring to FIG. 2A, a network gateway 202 of cloud-based security service 200 is implemented as a virtual network gateway 202 (e.g., a security platform, such as a firewall solution available from Palo Alto Networks, Inc., or another commercially available security platform solution can similarly be configured to implement the network gateway as disclosed herein) executing on a server in a data center. In this example, the network gateway is executed on a server in a data center of the GCP located in Germany. A user 204A, who is located in Italy, is securely connected (e.g., via an IPsec tunnel or another secure/Virtual Private Network (VPN) connection) to network gateway 202 that is located in Germany (e.g., the cloud-based security service provides an agent that is executed on the endpoint device of user 204A to automatically and securely connect the user to the nearest regional network gateway, in which the enterprise customer can, for example, select locations in the cloud-based security service that function as cloud-based network gateways to secure their mobile users, such as will be further described below). Similarly, a user 204B, who is located in Spain, is securely connected to network gateway 202 that is located in Germany. In an example implementation, the cloud-based security service also provides an agent (not shown) (e.g., an endpoint agent, such as the GlobalProtect agent available from Palo Alto Networks, Inc.) that can be executed on various computing platforms such as the endpoint devices (e.g., endpoint devices executing various Operating Systems (OSs), such as Linux OS, Microsoft Windows® OS, Apple Mac OS®, Apple iOS®, and Google Android® OS) of users 204A and 204B (e.g., as well as of other users and data appliances, servers, etc.) that facilitates such automatic and secure connections to the nearest gateway and/or based on other criteria (e.g., latency, workload balancing, etc.).

As shown in FIG. 2A, using the disclosed techniques, network gateway 202 automatically performs a Source NAT (SNAT) operation to assign an Italian public IP address (e.g., a public IP address that is associated with the geo location of Italy) as the egress IP address to be associated with the session for user 204A when connecting with the Microsoft Office 365® service shown at 222. Similarly, network gateway 202 automatically performs a SNAT operation to assign a Spanish public IP address (e.g., a public IP address that is associated with the geo location of Spain) as the egress IP address to be associated with the session for user 204B when connecting with the Microsoft Office 365® service shown at 222.

As shown at 222A and 222B, users 204A and 204B of the cloud-based security service can connect through network gateway 202 to access various SaaS applications, such as Microsoft Office 365® (e.g., and/or other Internet web sites/services), and such will be rendered/provided in the local language associated with each user's respective location as a result of the above-described SNAT operations performed by network gateway 202 (e.g., absent such SNAT operations, the SaaS applications such as Microsoft Office 365® would infer that the users are located in Germany based on the public IP address(es) associated with network gateway 202 that is located in Germany (e.g., a public IP address(es) that is associated with the geo location of Germany), which would not provide a desirable user localization experience).

Moreover, the public cloud provider, GCP in this example, provides high-speed network connectivity from each of their various regional cloud-based computing service data centers to one or more SaaS providers including Microsoft Office 365® (e.g., using the GCP premium network that utilizes Google owned fiber network connections from their regional cloud platform sites to various SaaS provider sites). As a result, users 204A and 204B of cloud-based security service 200 would also experience a lower latency when connecting to network gateway 202 to access such SaaS provider solutions (e.g., Microsoft Office 365®) thereby further enhancing the user experience when using the SaaS provider solution securely via the cloud-based security service.

FIG. 2B is another system diagram of an example cloud-based security service in accordance with some embodiments. In this example, network gateways 202A, 202B, and 202C of a cloud-based security service 200 are located in different geo locations as shown. As also shown, users of the cloud-based security service that are each located in different locations/regions can be automatically and securely connected to a network gateway of the cloud-based security service provider, such as further described below. For example, users located in Warsaw (Poland) are connected to a network gateway 202A in an eu-west-3 data center located in Frankfurt, Germany; users located in Vancouver, Canada are connected to a network gateway 202B in an us-west-1 data center located in Oregon, United States; and users located in San Francisco, CA are connected to a network gateway 202C in an us-west-2 data center also located in Oregon, United States. In an example implementation, the cloud-based security service can be implemented using a public cloud platform, such as GCP, that currently provides over 130 network edge locations (PoPs), and also provides for a low latency, low loss network with reduced Internet Service Provider (ISP) hops for users of the cloud-based security service to access various supported SaaS solutions as similarly described above.

In one embodiment, the disclosed network gateways (e.g., network gateway 202 of FIG. 2A and network gateways 202A-C of FIG. 2B) are configured to enforce policies (e.g., security policies) regarding communications between client devices and between client devices and servers/other devices, such as users/devices 204A and 204B (e.g., any endpoint device that can perform network communications) and, for example, external destinations (e.g., which can include any devices, servers, and/or web sites/services outside of a protected/secured enterprise network, which are reachable via an external network, such as the Internet). Examples of such policies include ones governing traffic shaping, quality of service, and routing of traffic. Other examples of policies include security policies such as ones requiring the scanning for threats in incoming (and/or outgoing) email attachments, website content, files exchanged through instant messaging programs, and/or other file transfers, etc. In some embodiments, the network gateway is also configured to enforce policies with respect to traffic that stays within a protected/secured enterprise network (not shown in FIGS. 2A and 2B).

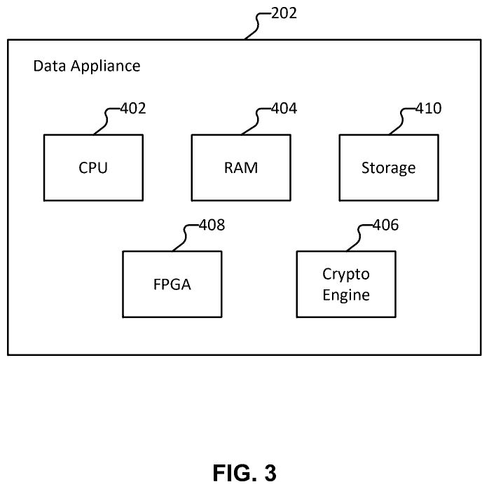

An embodiment of network gateway 202 is shown in FIG. 3. The example shown is a representation of physical components that can be included in network gateway 202 if the network gateway is implemented as a data appliance, in various embodiments. Specifically, the data appliance includes a high-performance multi-core Central Processing Unit (CPU) 402 and Random Access Memory (RAM) 404. The data appliance also includes a storage 410 (such as one or more hard disks or solid-state storage units). In various embodiments, the data appliance stores (whether in RAM 404, storage 410, and/or other appropriate locations) information used in monitoring an enterprise network and implementing the disclosed techniques. Examples of such information include application identifiers, content identifiers, user identifiers, requested URLs, IP address mappings, policy and other configuration information, signatures, hostname/URL categorization information, malware profiles, and machine learning models. The data appliance can also include one or more optional hardware accelerators. For example, the data appliance can include a cryptographic engine 406 configured to perform encryption and decryption operations, and one or more Field Programmable Gate Arrays (FPGAs) 408 configured to perform matching, act as network processors, and/or perform other tasks.

Functionality described herein as being performed by the data appliance can be provided/implemented in a variety of ways. For example, the data appliance can be a dedicated device or set of devices. The functionality provided by the data appliance can also be integrated into or executed as software on a general purpose computer, a computer server, a gateway, and/or a network/routing device. In some embodiments, at least some services described as being provided by the data appliance are instead (or in addition) provided to a client device (e.g., client device 204A) by software executing on the client device.

Whenever the data appliance is described as performing a task, a single component, a subset of components, or all components of the data appliance may cooperate to perform the task. Similarly, whenever a component of the data appliance is described as performing a task, a subcomponent may perform the task and/or the component may perform the task in conjunction with other components. In various embodiments, portions of the data appliance are provided by one or more third parties. Depending on factors such as the amount of computing resources available to the data appliance, various logical components and/or features of the data appliance may be omitted, and the techniques described herein adapted accordingly. Similarly, additional logical components/features can be included in embodiments of the data appliance as applicable. One example of a component included in the data appliance in various embodiments is an application identification engine which is configured to identify an application (e.g., using various application signatures for identifying applications based on packet flow analysis). For example, the application identification engine can determine what type of traffic a session involves, such as Web Browsing—Social Networking; Web Browsing—News; SSH; and so on.

The disclosed system processing architecture can be used with different types of clouds in different deployment scenarios, such as the following: (1) public cloud; (2) private cloud on-premises; and (3) inside high-end physical firewalls, and some processing power can be allocated to execute a private cloud (e.g., using the management plane (MP) in the Palo Alto Networks PA-5200 Series firewall appliances).

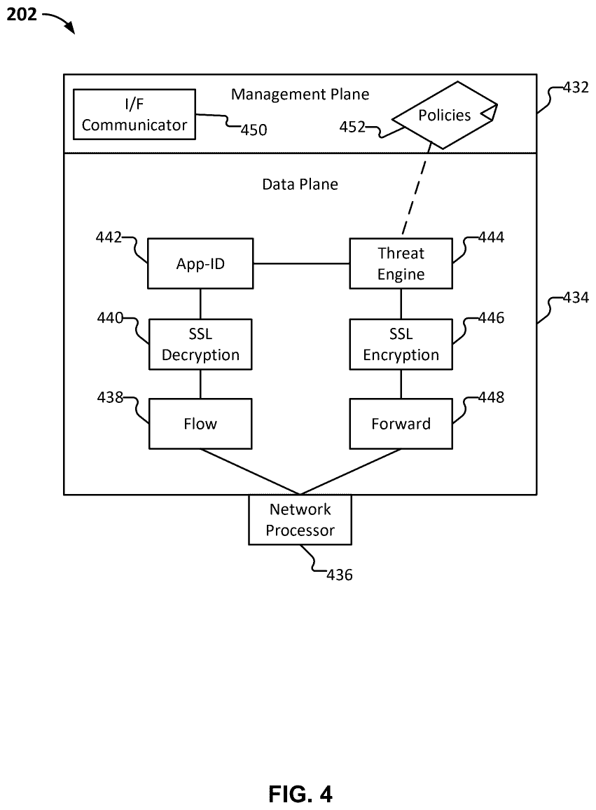

FIG. 4 is a functional diagram of logical components of an embodiment of a data appliance. The example shown is a representation of logical components that can be included in network gateway 202 in various embodiments. Unless otherwise specified, various logical components of network gateway 202 are generally implementable in a variety of ways, including as a set of one or more scripts (e.g., written in Java, python, etc., as applicable).

As shown, network gateway 202 comprises a firewall, and includes a management plane 432 and a data plane 434. The management plane is responsible for managing user interactions, such as by providing a user interface for configuring policies and viewing log data. The data plane is responsible for managing data, such as by performing packet processing and session handling.

Network processor 436 is configured to receive packets from client devices, such as client devices 204A and 204B, and provide them to data plane 434 for processing. Whenever flow module 438 identifies packets as being part of a new session, it creates a new session flow. Subsequent packets will be identified as belonging to the session based on a flow lookup. If applicable, SSL decryption is applied by SSL decryption engine 440. Otherwise, processing by SSL decryption engine 440 is omitted. Decryption engine 440 can help network gateway 202 inspect and control SSL/TLS and SSH encrypted traffic, and thus help to stop threats that might otherwise remain hidden in encrypted traffic. Decryption engine 440 can also help prevent sensitive content from leaving an enterprise/secured customer's network. Decryption can be controlled (e.g., enabled or disabled) selectively based on parameters such as: URL category, traffic source, traffic destination, user, user group, and port. In addition to decryption policies (e.g., that specify which sessions to decrypt), decryption profiles can be assigned to control various options for sessions controlled by the policy. For example, the use of specific cipher suites and encryption protocol versions can be required.

Application identification (APP-ID) engine 442 is configured to determine what type of traffic a session involves. As one example, application identification engine 442 can recognize a GET request in received data and conclude that the session requires an HTTP decoder. In some cases, e.g., a web browsing session, the identified application can change, and such changes will be noted by network gateway 202. For example, a user may initially browse to a corporate Wiki (classified based on the URL visited as “Web Browsing—Productivity”) and then subsequently browse to a social networking site (classified based on the URL visited as “Web Browsing—Social Networking”). Different types of protocols have corresponding decoders.

Based on the determination made by application identification engine 442, the packets are sent, by threat engine 444, to an appropriate decoder configured to assemble packets (which may be received out of order) into the correct order, perform tokenization, and extract out information. Threat engine 444 also performs signature matching to determine what should happen to the packet. As needed, SSL encryption engine 446 can re-encrypt decrypted data. Packets are forwarded using a forward module 448 for transmission (e.g., to a destination).

As also shown in FIG. 4, policies 452 are received and stored in management plane 432. Policies can include one or more rules, which can be specified using domain and/or host/server names, and rules can apply one or more signatures or other matching criteria or heuristics, such as for security policy enforcement for subscriber/IP flows based on various extracted parameters/information from monitored session traffic flows. An interface (I/F) communicator 450 is provided for management communications (e.g., via (REST) APIs, messages, or network protocol communications or other communication mechanisms).

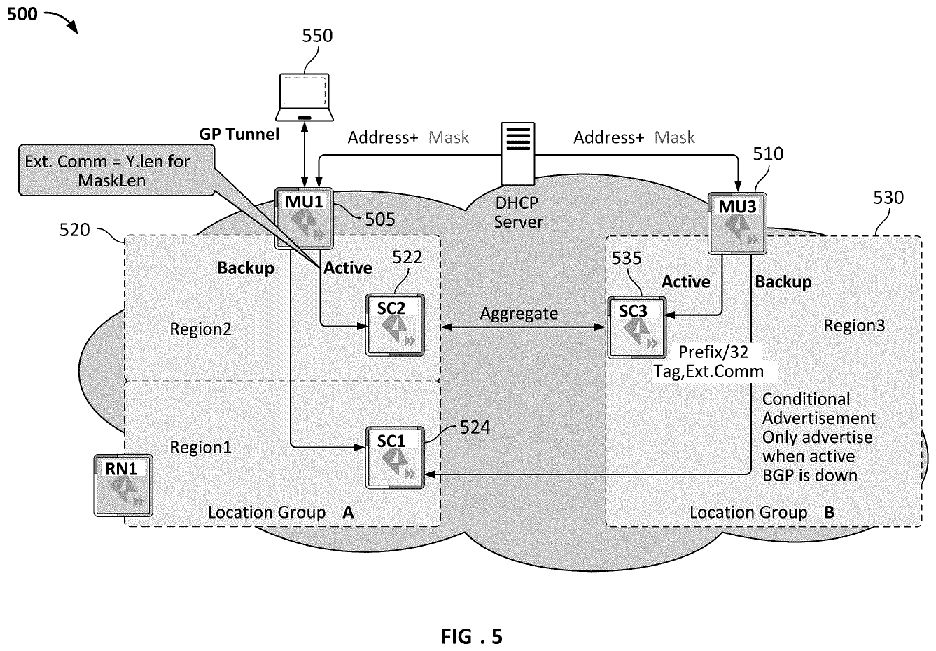

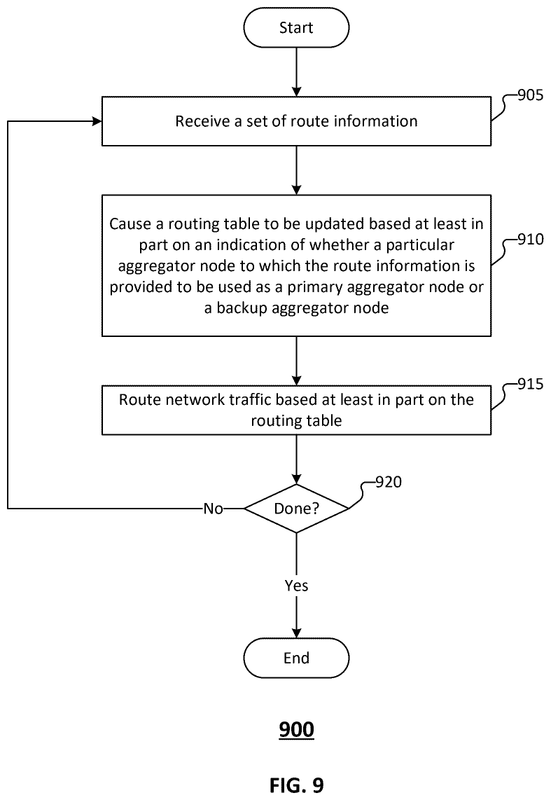

FIG. 5 is a block diagram of a network system according to various embodiments. In some embodiments, system 500 is implemented at least in part by system 100 of FIG. 1. System 500 may be implemented in connection with cloud-based security service 200. In some embodiments, system 500 implements process 900, 1000, 1100, 1200, and/or 1300 of FIGS. 9-13.

In the example shown, system 500 comprises contributor nodes 505, 510, cloud service location A 520, cloud service location B 530, and client system 550.

In the context of BGP (Border Gateway Protocol) dynamic route aggregation, the contributor node is typically a BGP router or network device that provides specific, detailed routing information (also called prefixes) to one or more aggregator nodes. These contributors may represent various types of entities within the network, depending on the specific deployment or use case.

Contributor nodes 505, 510 can be various types of devices. Examples of types of devices that can be implemented as contributor nodes 505, 510, include (a) edge routers (e.g., Customer Premises Equipment—CPE), (b) access routers (e.g., within an autonomous system), (c) data center or cloud gateway routers, (d) provider edge (PE) Routers in MPLS/VPN networks, (e) branch office or remote site routers, (f) Internet Service Provider (ISP) customer routers, and/or (g) multi-user nodes. Various other types of devices may be implemented.

In many networks, edge routers, also known as customer premises equipment (CPE), serve as the contributor nodes. These routers are located at the boundary of a customer's network and connect to a service provider's network. The edge router advertises specific routes (such as customer-owned IP prefixes) to upstream aggregator routers operated by the service provider. The service provider then aggregates these specific routes before advertising them to other networks.

Inside an Autonomous System (AS), an access router or distribution router can act as a contributor node. These routers are often responsible for routing traffic from specific network segments, such as subnets within a data center, office, or regional branch. They advertise detailed local routes to the core or aggregation routers, which then summarize the routes and propagate them across the larger AS or to external networks.

In cloud environments or data centers, gateway routers that connect the internal network to the external world can serve as contributor nodes. These routers might advertise specific internal routes (e.g., subnets or tenant networks) to aggregator nodes, which summarize and distribute those routes either within the data center's internal routing infrastructure or to external networks (such as the internet or other data centers).

In Multi-Protocol Label Switching (MPLS) and Virtual Private Network (VPN) architectures, provider edge (PE) routers act as contributors by advertising specific customer routes to core routers (P routers) within the service provider's network. These PE routers contribute the routes learned from their connected customers, and these routes are often aggregated by the core routers before being advertised to other parts of the provider's network or to external networks.

In a distributed enterprise network, branch office routers or routers at remote sites can act as contributor nodes. These routers advertise specific routes, such as IP subnets or segments within the branch, back to a central aggregator node (e.g., a core router at the headquarters). The central aggregator may then summarize the routes from various branches before advertising them to the wider network or internet.

In the context of ISPs, customer routers (e.g., enterprise or small business routers) act as contributor nodes by advertising specific IP prefixes, such as those assigned to the customer's network, to the ISP's aggregator routers. The ISP's network then aggregates these customer routes for more efficient propagation to upstream networks or other peers.

Returning to FIG. 5, contributor node 505 can use aggregator nodes to advertise route aggregations for cloud service location A 520. In the example shown, contributor node 505 uses aggregator node 522 and aggregator node 524 to advertise route aggregations. In some embodiments, contributor node 505 determines that aggregator node 522 is to serve as the primary aggregator node (e.g., denoted as “active”) and that aggregator node 524 is to serve as the backup aggregator node (e.g., denoted as “backup”).

Similarly, contributor node 510 can use aggregator nodes to advertise route aggregations for cloud service location B 530. In the example shown, contributor node 510 uses aggregator node 535 and aggregator node 524 to advertise route aggregations. In some embodiments, contributor node 510 determines that aggregator node 535 is to serve as the primary aggregator node (e.g., denoted as “active”) and that aggregator node 524 is to serve as the backup aggregator node (e.g., denoted as “backup”).

According to various embodiments, the contributor node provides to aggregator nodes a network prefix (e.g., a set of addresses for the contributor node) for which the aggregator nodes are to advertise route aggregations for the contributor node. In some embodiments, the system uses an indicator to distinguish between primary aggregator nodes and backup aggregator nodes, such as to distinguish between route aggregations advertised by the primary aggregator node and the corresponding backup aggregator nodes. The indicator may correspond to a value (e.g., an offset value) that aggregator nodes use to configure the local preference values (e.g., LOCAL_PREF) provided in connection with the advertised route aggregations.

In some embodiments, the system comprises a contributor node that sets an offset value based on whether the aggregator node to which a network prefix is to be provided is to be used as a primary aggregator or backup aggregator node. Additionally, the contributor node can set the offset value based on a ranking of the backup aggregator nodes, such as to denote a preference ranking in which backup aggregator nodes are to be used. The offset value can be encoded into information that the contributor node(s) provide to aggregator nodes in connection with identifying the network prefix corresponding to the route aggregations to be advertised by the aggregator nodes.

In some embodiments, the contributor node sets the offset value (if any) for an aggregator node to be used as a primary aggregator node to be different from the offset value to be provided to (and used by) aggregator nodes to be used as backup aggregator nodes. As an example, the contributor node provides an offset value set to zero for an aggregator node to be used as the primary aggregator node, and the contributor node provides an offset value set to non-zero for an aggregator node to be used as the backup aggregator node. As another example, the contributor node provides to a backup aggregator node an offset value that is greater than the offset value provided to a primary aggregator node.

In some embodiments, the contributor node provides to a backup aggregator node an offset value, and either does not provide an offset value to a primary aggregator node or provides a null offset value to the primary aggregator node.

In some embodiments, the aggregator nodes that are to be implemented to advertise route aggregations for a contributor node are configured to use the same initial local preference value. The aggregator nodes adjust the initial local preference value based at least in part on the offset value (if any) that the aggregator nodes respectively receive from the contributor node in connection with the contributor node providing the aggregator nodes with the network prefix for the route aggregation. As an illustrative example, the initial local preference value is set to 100. However, various other initial local preference values can be implemented.

In some embodiments, the system is configured such that the aggregator nodes implement a predefined algorithm or process to determine the local preference value (e.g., the updated local preference value, or LOCAL_PREF) to be provided with the route aggregations advertised by the aggregator nodes. For example, the local preference value (e.g., the updated local preference value) is determined based on subtracting the corresponding offset value from the initial local preference value. Using this mechanism to determine the local preference value to be provided with the route aggregation advertisements, the local preference value for a primary aggregator node is higher than a local preference value for a backup aggregator node.

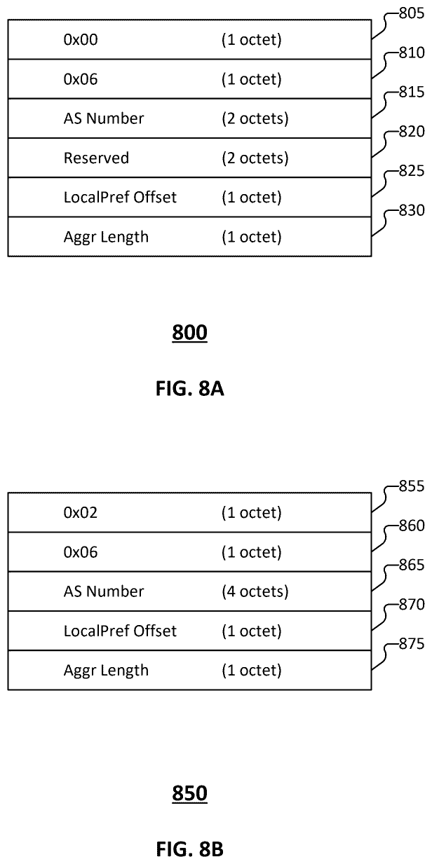

Returning to the example shown, contributor node 505 determines to use aggregator node 522 (e.g., a service control node) as the primary aggregator node and to use aggregator node 524 as the backup aggregator node. Accordingly, contributor node 505 provides to aggregator node 522 and aggregator node 524 with a network prefix. The network prefix may carry an extended community, such as encoding 800 of FIG. 8A or encoding 850 of FIG. 8B. In connection with providing the network prefix, contributor node 505 provides an offset value at least to the backup aggregator node (e.g., aggregator node 524). In embodiments where contributor node 505 additionally provides an offset value to the primary aggregator node (e.g., aggregator node 522), the offset values provided to the primary aggregator node and the backup aggregator nodes are different. For example, the offset value provided to the primary aggregator node may be set to zero, and the offset value provided to the backup aggregator node may be set to a non-zero value. As another example, the offset value provided to the primary aggregator node is set at a value less than the value for the offset value provided to the backup aggregator node.

In response to receiving the network prefix, aggregator node 522 and aggregator node 524 can advertise a corresponding route aggregation. The aggregator nodes can determine a local preference value (e.g., LOCAL_PREF value) to be provided in connection with the advertised route aggregations based at least in part on an offset value (if any) received from the contributor node. In some embodiments, the aggregator node(s) (e.g., aggregator node 524 to serve as the backup aggregator node) determines the local preference value to be provided in connection with the advertised route aggregations based on a predefined initial local preference value and the offset value received from the contributor node. The aggregator node(s) can adjust the initial local preference value based on the offset value (if any) to obtain the updated local preference value to be provided in connection with the advertised route aggregations.

Although the foregoing example is described in the context of an offset value being used to adjust an initial local preference value based on a subtraction of the offset value (e.g., to ensure the LOCAL_PREF value for a primary aggregator node is higher than the LOCAL_PREF for a backup aggregator node), various other embodiments may implement the setting an offset value for a primary aggregator node to be higher than the offset value for a backup aggregator node and adjusting the initial local preference value by adding the offset value to the initial local preference value (e.g., to similarly ensure the LOCAL_PREF value for a primary aggregator node is higher than the LOCAL_PREF for a backup aggregator node).

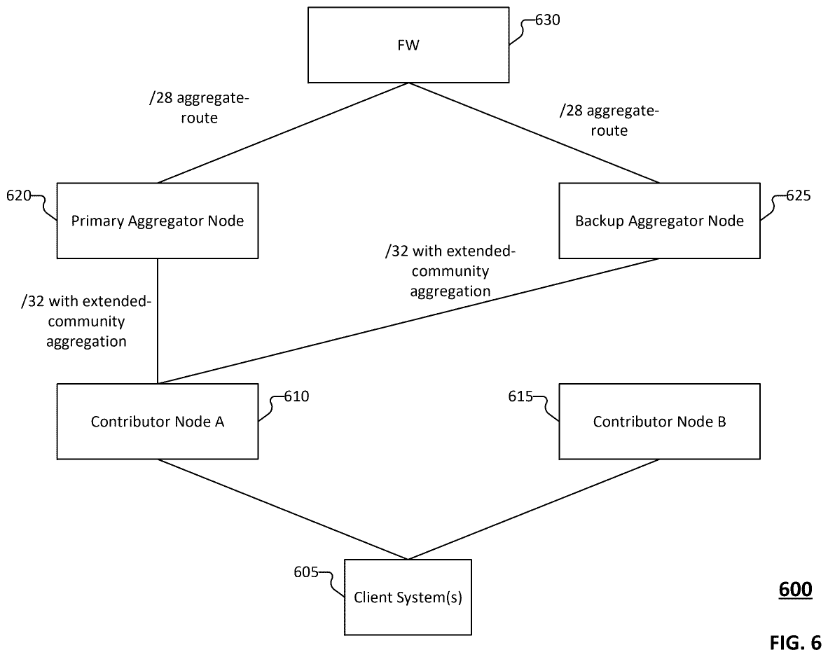

FIG. 6 is a block diagram of a route aggregation service. In some embodiments, system 600 is implemented at least in part by system 100 of FIG. 1. System 600 may be implemented in connection with cloud-based security service 200.

In the example shown, system 600 implements a plurality of contributor nodes and aggregator nodes. System 600 implements an offset value, which can be used in connection with distinguishing route aggregations advertised by aggregator nodes. As illustrated, system 600 comprises a set of client systems 605 (e.g., one or more client systems), contributor node A 610, contributor node B 615, aggregator nodes (e.g., primary aggregator node 620 and backup aggregator node 625), and firewall 630. The set of client systems 605 can connect to the network via contributor node A 610 or contributor node B 615.

As illustrated, contributor node A 610 determines to use two aggregator nodes to advertise route aggregations (e.g., primary aggregator node 620 and backup aggregator node 625). As an example, contributor node A 610 determines primary aggregator node 620 to be the primary aggregator for which the route aggregation of the contributor node A 610 is to be advertised. Similarly, contributor node A 610 determines backup aggregator node 625 to be a backup aggregator for which the route aggregation of the contributor node A 610 is to be advertised.

In the example shown, system 600 does not implement an offset value to distinguish between route aggregations advertised by aggregator nodes. For example, contributor node A 610 does not provide primary aggregator node 620 or backup aggregator node 625 an offset value to be used to adjust a local preference value. As illustrated, contributor node A 610 provides primary aggregator node 620 provides a network prefix (e.g., a/32 with an extended community aggregation) and provides the same network prefix to backup aggregator node 625. Accordingly, both primary aggregator node 620 and backup aggregator node 625 advertise to firewall 630 the same route aggregation. Firewall 630 is thus unable to distinguish between the route aggregations being advertised by primary aggregator node 620 and backup aggregator node 625 and is unable to determine, based on the route aggregation, which aggregator node is deemed to be the primary aggregator node and which aggregator node is deemed to be the backup aggregator node.

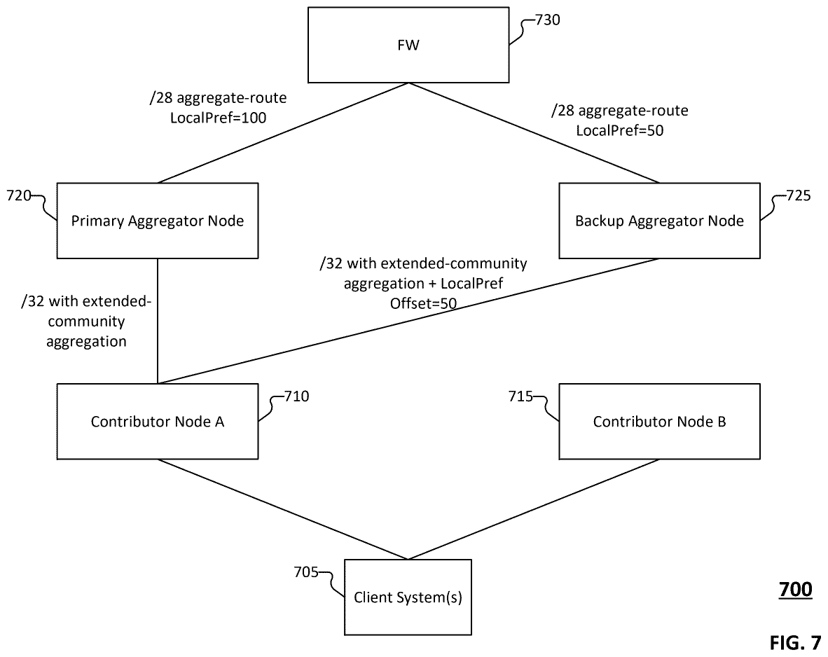

FIG. 7 is a block diagram of a route aggregation service according to various embodiments. In some embodiments, system 700 is implemented at least in part by system 100 of FIG. 1. System 700 may be implemented in connection with cloud-based security service 200. In some embodiments, system 600 implements process 900, 1000, 1100, 1200, and/or 1300 of FIGS. 9-13.

In the example shown, system 700 implements a plurality of contributor nodes and aggregator nodes. System 700 implements an offset value, which can be used in connection with distinguishing route aggregations advertised by aggregator nodes. As illustrated, system 700 comprises a set of client systems 705 (e.g., one or more client systems), contributor node A 710, contributor node B 715, aggregator nodes (e.g., primary aggregator node 720 and backup aggregator node 725), and firewall 730. The set of client systems 705 can connect to the network via contributor node A 710 or contributor node B 715.

As illustrated, contributor node A 710 determines to use two aggregator nodes to advertise route aggregations. As an example, contributor node A 710 determines primary aggregator node 720 to be the primary aggregator for which the route aggregation of the contributor node A 710 is to be advertised. Similarly, contributor node A 710 determines backup aggregator node 725 to be a backup aggregator for which the route aggregation of the contributor node A 710 is to be advertised.

According to various embodiments, contributor node A 710 provides indications to the aggregator nodes (e.g., primary aggregator node 720 and/or backup aggregator node 725) of whether the aggregator nodes are to be used as primary aggregator nodes or backup aggregator nodes, or indications of how a local preference value is to be adjusted (e.g., the offset value).

In the example shown, contributor node A 710 provides primary aggregator node 720 with a network prefix, such as a/32 with an extended community aggregation. In some embodiments, contributor node A provides primary aggregator node 720 with a null offset value (e.g., the offset value field in the encoding is left blank). In some embodiments, contributor node A provides primary aggregator node 720 with an offset value set to zero.

In the example shown, contributor node A 710 provides backup aggregator node 725 with a network prefix, such as a/32 with an extended community aggregation. Contributor node A 710 further provides backup aggregator node 725 with an offset value (e.g., a LOCAL_PREF value). In some embodiments, contributor node A provides primary aggregator node 720 with a null offset value (e.g., the offset value field in the encoding is left blank). In some embodiments, contributor node A provides primary aggregator node 720 with an offset value set to zero. In the example shown, the offset value provided to backup aggregator node 725 is set to 50. However, various other non-zero offset values may be used in connection with providing network prefixes to backup aggregator nodes.

In some embodiments, a contributor node provides non-zero offset values to backup aggregator nodes. The contributor node may additionally provide an offset value (e.g., an offset value set to zero) to a primary aggregator node. Alternatively, the contributor node may provide a null offset value to the primary aggregator node. In connection with advertising a route aggregation for a contributor node, the various aggregator nodes (e.g., the primary aggregator node and one or more backup aggregator nodes) can implement the same initial local preference value. The various aggregator nodes can then determine an updated local preference value (e.g., LOCAL_PREF value to be used in the advertisement) based on the offset value.

The aggregator nodes can adjust the local preference value to obtain an updated local preference value to be used in connection with advertising route aggregations for the contributor node. In the example shown, both primary aggregator node 720 and backup aggregator node 725 implement an initial local preference value equal to 100. For example, backup aggregator node 725 updates a local preference value to obtain an updated local preference value equal to 50 (e.g., LOCAL_PREF=50) and advertises an aggregate route for contributor node A 710. In contrast, primary aggregator node 720 can use an initial local preference value adjusted by any offset value provided by contributor node A 710. In the example shown, contributor node 710 provides a null offset value or an offset value set to zero, and primary aggregator node 720 advertises a route aggregation for contributor node A 710 with a local preference value (e.g., updated local preference value, or LOCAL_PREF) set to 100.

According to various embodiments, the contributor node provides different offset values to each aggregator node to be used to advertise the contributor node's route aggregation. In some embodiments, the offset value (if any) provided to a primary aggregator node is less than the offset value(s) provided to the corresponding backup aggregator node(s).

Although FIG. 7 illustrates contributor node A 710's use of two aggregator nodes, according to various embodiments, various other numbers of backup aggregator nodes can be implemented. Contributor node A 710 can provide the various different backup aggregator nodes with different offset values (e.g., LOCAL_PREF Offsets), which can be used to adjust the local preference value to obtain an updated local preference value. Because the various different backup aggregator nodes are provided with different offset values, the route aggregations advertised by the various different backup aggregator nodes have different local preference values (e.g., different updated local preference values).

Extended community encoding is an enhancement of the standard BGP (Border Gateway Protocol) community attribute, allowing for more detailed and flexible control over routing policies across networks. While the standard BGP community attribute has a 32-bit structure, the extended community expands this capability with a 64-bit structure, providing a larger and more flexible space for encoding route attributes. This expanded structure enables network operators to apply more complex routing policies and better manage large-scale networks.

An extended community consists of 8 octets (64 bits) and is divided into two main parts. The first part is a 2-octet Type field, which defines the type and subtype of the extended community. The type field helps specify the nature of the community, such as whether it is transitive or non-transitive, as well as the purpose of the extended community. The second part of the extended community is the Value field, which spans 6 octets. The value field contains the specific data relevant to the type and subtype, such as an Autonomous System (AS) number, IP address, or other routing information. This structure allows for greater flexibility in the types of routing information that can be encoded.

There are two broad categories of extended communities: transitive and non-transitive. Transitive extended communities are intended to be shared across Autonomous System boundaries, making them useful for routing policies that need to apply globally. A common use case for transitive communities is in BGP/MPLS VPNs, where policies may need to extend across multiple service providers or networks. On the other hand, non-transitive extended communities are confined to a single AS and are not shared beyond that AS. These are used for localized routing policies that do not need to affect external networks.

Extended communities are particularly valuable in BGP/MPLS VPN environments, where they play an important role in managing route targets and route origins. For example, a Route Target (RT) extended community is commonly used to control which routes should be imported into a specific VPN routing table. This allows network operators to define which customer routes are available in certain parts of the service provider's network, enabling efficient and controlled VPN routing. Similarly, a Route Origin (RO) extended community can be used to identify the origin of a route, which is important for route filtering and preventing routing loops in complex network environments.

In addition to VPNs, extended communities are also useful for traffic engineering and advanced routing policy control. By encoding additional information such as bandwidth requirements, geographic location, or traffic load, extended communities help network operators make more informed and optimized routing decisions. This can be particularly useful for managing traffic across large, multi-AS networks where different parts of the network have varying capabilities and policies.

By expanding the community attribute to 64 bits and introducing transitive and non-transitive types, extended communities enable network operators to better manage the flow of data across complex, distributed networks, making them an integral part of large-scale BGP implementations.

FIG. 8A is an example of an extended community encoding according to various embodiments. In some embodiments, encoding 800 is implemented at least in part by system 100 of FIG. 1. Encoding 800 may be implemented in connection with cloud-based security service 200. In some embodiments, encoding 800 can be implemented in connection with process 900, 1000, 1100, 1200, and/or 1300 of FIGS. 9-13.

As illustrated, encoding 800 is an example of an extended community encoding for a transitive two-octet AS-specific extended community encoding. In the example shown, encoding 800 comprises field 805, field 810, field 815, field 820, field 825, and field 830.

Field 805 is a 1-octet field that indicates the type of encoding. For example, the value 0x00 indicates a type of encoding 800. Field 810 is a 1-octet field that indicates a specific allocation of the sub-type being implemented. Field 810 can carry aggregation information. Fields 815, 820, 825, and 830 can correspond to the value field of the 2-octet type field.

Field 815 is a two-octet field that indicates an identifier that identifies the autonomous system (AS). For example, field 815 stores the AS number. Field 820 is a two-octet reserved field. Field 825 is a 1-octet field that is used to store an offset value (e.g., a LOCAL_PREF offset). The offset value can be set by the corresponding contributor node and is used to adjust a local preference value (e.g., to obtain an updated local preference value, as described herein). Field 830 is a 1-octet field that stores information pertaining to an aggregation length. For example, field 830 may store the network prefix. For example, the aggregation length corresponds to a block range.

FIG. 8B is an example of an extended community encoding according to various embodiments. In some embodiments, encoding 850 is implemented at least in part by system 100 of FIG. 1. Encoding 850 may be implemented in connection with cloud-based security service 200. In some embodiments, encoding 850 can be implemented in connection with process 900, 1000, 1100, 1200, and/or 1300 of FIGS. 9-13.

As illustrated, encoding 850 is an example of an extended community encoding for a transitive four-octet AS-specific extended community encoding. In the example shown, encoding 850 comprises field 855, field 860, field 865, field 870, and field 875. In contrast to encoding 800, encoding 850 does not have a reserved field. For example, encoding 850 uses the 2-octets allocated to be a reserved field for encoding 800 to implement a 4-octet field to store the AS identifier.

Field 855 is a 1-octet field that indicates the type of encoding. For example, the value 0x02 indicates a type of encoding 850. Field 860 is a 1-octet field that indicates a specific allocation of the sub-type being implemented. Field 860 can carry aggregation information. Fields 865, 870, and 875 can correspond to the value field of the 2-octet type field.

Field 865 is a four-octet field that indicates an identifier that identifies the autonomous system (AS). For example, field 865 stores the AS number. Field 870 is a 1-octet field that is used to store an offset value (e.g., a LOCAL_PREF offset). The offset value can be set by the corresponding contributor node and is used to adjust a local preference value (e.g., to obtain an updated local preference value, as described herein). Field 875 is a 1-octet field that stores information pertaining to an aggregation length. For example, field 875 may store the network prefix. For example, the aggregation length corresponds to a block range.

FIG. 9 is a flow diagram of a method for routing network traffic according to various embodiments. In some embodiments, process 900 is implemented at least in part by system 100 of FIG. 1, system 500 of FIG. 5, and/or system 700 of FIG. 7. In some embodiments, process 900 is implemented by a networking service or an aggregator node.

At 905, the system receives a set of route information. At 910, the system causes a routing table to be updated based at least in part on an indication of whether a particular aggregator node to which the route information is provided to be used as a primary aggregator node or a backup aggregator node. At 915, the system routes network traffic based at least in part on the routing table. At 920, the system determines whether process 900 is complete. In some embodiments, process 900 is determined to be complete in response to a determination that no further network traffic is to be routed, no further routes are to be aggregated, no further aggregated routes are to be advertised, an administrator indicates that process 900 is to be paused or stopped, etc. In response to a determination that process 900 is complete, process 900 ends. In response to a determination that process 900 is not complete, process 900 returns to 905.

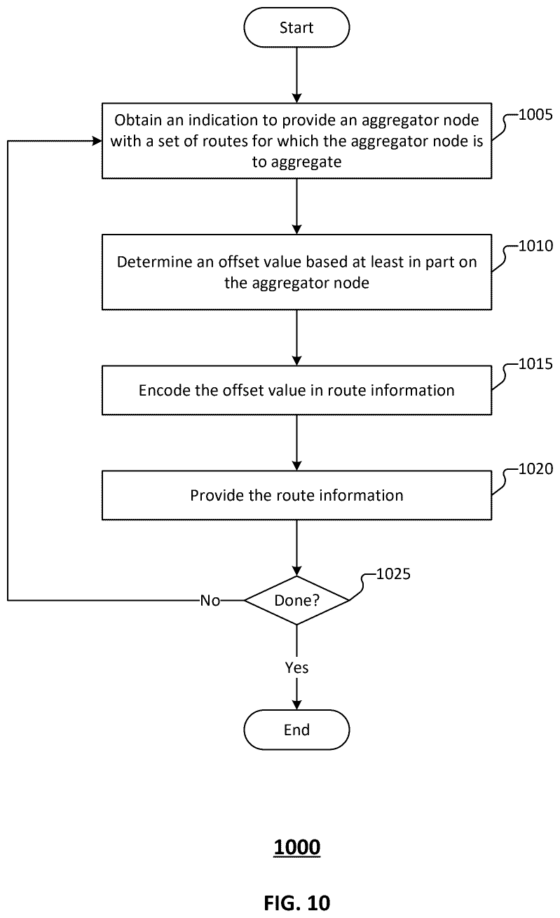

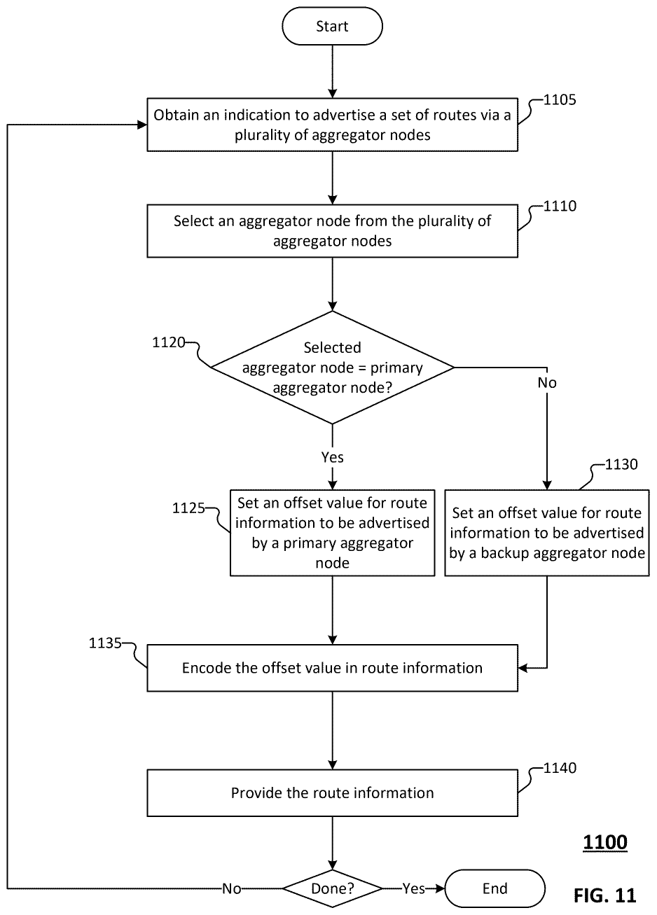

FIG. 10 is a flow diagram of a method for providing route information according to various embodiments. In some embodiments, process 1000 is implemented at least in part by system 100 of FIG. 1, system 500 of FIG. 5, and/or system 700 of FIG. 7. In some embodiments, process is implemented by a contributor node, such as contributor node 710 of FIG. 7.

At 1005, the system obtains an indication to provide an aggregator node with a set of routes (e.g., a network prefix) for which the aggregator node is to aggregate. At 1010, the system determines an offset value based at least in part on the aggregator node. At 1015, the system encodes the offset value in route information. At 1020, the system provides the route information. For example, the system provides the route information to an aggregator node to be used to advertise a route aggregation based on the set of routes. In some embodiments, the offset value encoded in the route information is determined based at least in part on a determination that the aggregator node to which the set of routes is to be provided is to be used as a primary aggregator node or a backup aggregator node, and in some implementations where a plurality of backup aggregator nodes are to be implemented, based further on a preference ranking of the backup aggregator node. At 1025, the system determines whether process 1000 is complete. In some embodiments, process 1000 is determined to be complete in response to a determination that no further network traffic is to be routed, no further route information is to be provided to an aggregator node(s), no further route information or aggregated routes are to be advertised, no further routes are to be aggregated, an administrator indicates that process 1000 is to be paused or stopped, etc. In response to a determination that process 1000 is complete, process 1000 ends. In response to a determination that process 1000 is not complete, process 1000 returns to 1005.

FIG. 11 is a flow diagram of a method for providing route information according to various embodiments. In some embodiments, process 1100 is implemented at least in part by system 100 of FIG. 1, system 500 of FIG. 5, and/or system 700 of FIG. 7. In some embodiments, process is implemented by a contributor node, such as contributor node 710 of FIG. 7.

At 1105, the system obtains an indication to advertise a set of routes via a plurality of aggregator nodes. At 1110, the system selects an aggregator node from the plurality of aggregator nodes. At 1120, the system determines whether the selected aggregator node corresponds to a primary aggregator node. For example, the system determines whether the selected aggregator node is to be used as the primary aggregator node with respect to route information being advertised for a contributor node. In response to determining that the selected aggregator node corresponds to the primary aggregator node, process 1100 proceeds to 1125 at which the system sets an offset value for route information to be advertised by a primary aggregator node. Conversely, in response to determining that the selected aggregator node does not correspond to the primary aggregator node, process 1100 proceeds to 1130 at which the system sets the offset value for the route information to be advertised by a backup aggregator node. At 1135, the system encodes the offset value in route information. At 1140, the system provides the route formation. At 1145, the system determines whether process 1100 is complete. In some embodiments, process 1100 is determined to be complete in response to a determination that no further network traffic is to be routed, no further route information is to be provided to an aggregator node(s), no further route information or aggregated routes are to be advertised, no further routes are to be aggregated, an administrator indicates that process 1100 is to be paused or stopped, etc. In response to a determination that process 1100 is complete, process 1100 ends. In response to a determination that process 1100 is not complete, process 1100 returns to 1105.

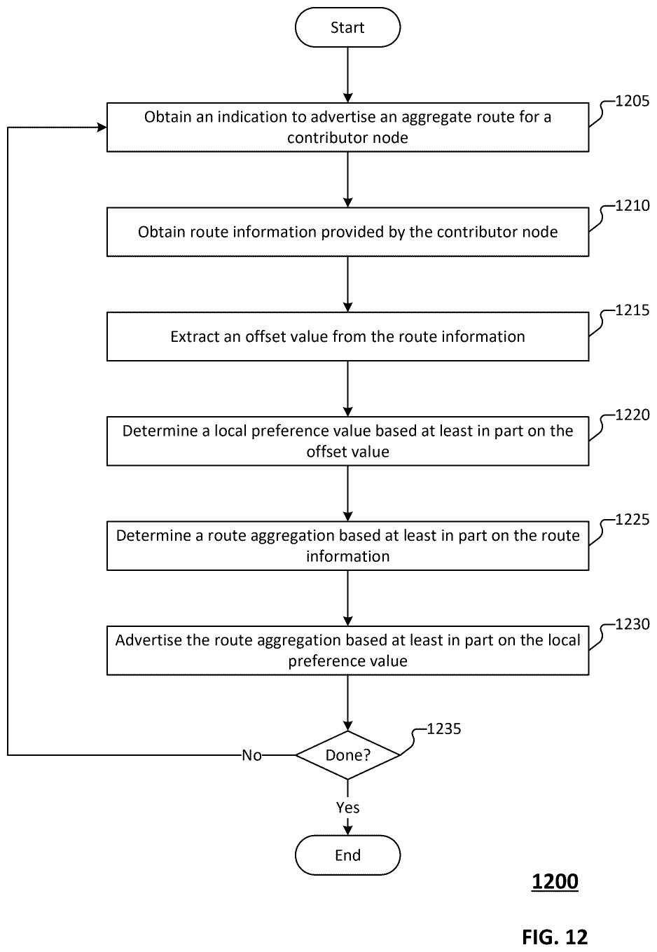

FIG. 12 is a flow diagram of a method for advertising a route aggregation according to various embodiments. In some embodiments, process 1200 is implemented at least in part by system 100 of FIG. 1, system 500 of FIG. 5, and/or system 700 of FIG. 7. In some embodiments, process 1200 is implemented by an aggregator node, such as primary aggregator node 720 and/or backup aggregator node 725 of FIG. 7.

At 1205, the system obtains an indication to advertise an aggregate route for a contributor node. At 1210, the system obtains route information provided by the contributor node. At 1215, the system extracts an offset value from the route information. At 1220, the system determines a local preference value based at least in part on the offset value. For example, the system obtains an initial local preference value and adjusts the initial local preference value based on the offset to obtain an updated local preference value (e.g., the LOCAL_PREF) to be provided in connection with the advertising of the route aggregation. At 1225, the system determines a route aggregation based at least in part on the route information. At 1230, the system advertises the route aggregation based at least in part on the local preference value. At 1235, the system determines whether process 1200 is complete. In some embodiments, process 1200 is determined to be complete in response to a determination that no further network traffic is to be routed, no further route information or aggregated routes are to be advertised, no further routes are to be aggregated, an administrator indicates that process 1200 is to be paused or stopped, etc. In response to a determination that process 1200 is complete, process 1200 ends. In response to a determination that process 1200 is not complete, process 1200 returns to 1205.

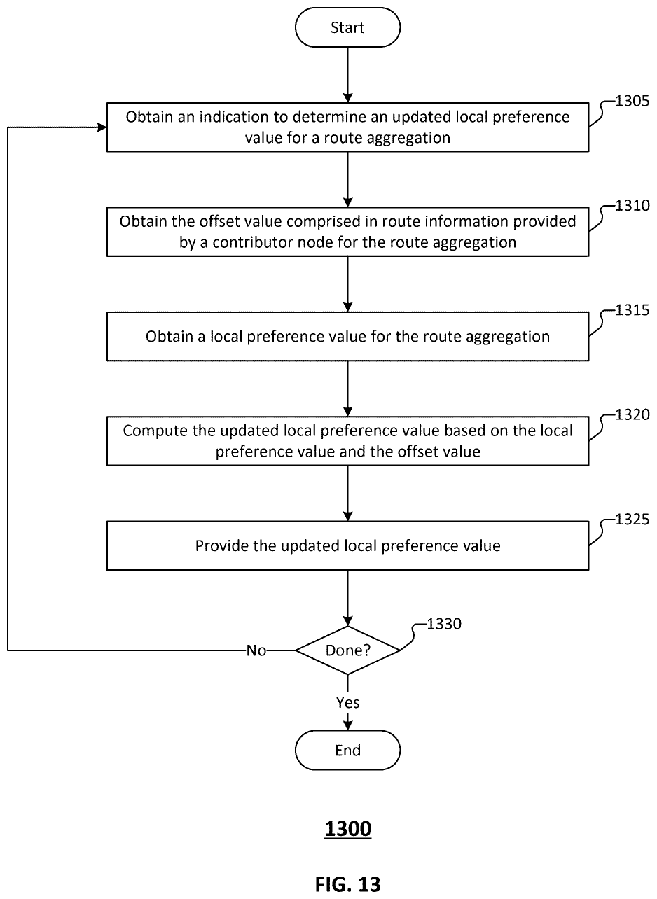

FIG. 13 is a flow diagram of a method for determining a local preference value for a route aggregation according to various embodiments. In some embodiments, process 1300 is implemented at least in part by system 100 of FIG. 1, system 500 of FIG. 5, and/or system 700 of FIG. 7. In some embodiments, process 1300 is implemented by an aggregator node, such as primary aggregator node 720 and/or backup aggregator node 725 of FIG. 7.

At 1305, the system obtains an indication to determine an updated local preference value for a route aggregation. At 1310, the system obtains the offset value comprised in route information provided by a contributor node for the route aggregation. At 1315, the system obtains a local preference value for the route aggregation. At 1320, the system computes the updated local preference value based on the local preference value and the offset value. At 1325, the system provides the updated local preference value. At 1330, the system determines whether process 1300 is complete. In some embodiments, process 1300 is determined to be complete in response to a determination that no further network traffic is to be routed, no further route information or aggregated routes are to be advertised, no further routes are to be aggregated, an administrator indicates that process 1300 is to be paused or stopped, etc. In response to a determination that process 1300 is complete, process 1300 ends. In response to a determination that process 1300 is not complete, process 1300 returns to 1305.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
receive, at least indirectly from one or more contributor nodes, a set of route information, wherein:
route information obtained from a particular contributor node comprises a network prefix, and one or more attributes; and
the one or more attributes comprises an indication of whether a particular aggregator node to which the route information is provided to be used as a primary aggregator node or a backup aggregator node;
cause a routing table to be updated based at least in part on the indication; and
route network traffic based at least in part on the routing table; and
a memory coupled to the one or more processors and configured to provide the one or more processors with instructions.

2. The system of claim 1, wherein indication is an offset value.

3. The system of claim 1, wherein:
the one or more attributes for route information received from the particular contributor comprises a local preference attribute;
the indication comprises an offset value; and
the offset value is used to update a local preference value comprised in the local preference attribute, the local preference value used to indicate a preferred aggregator node via which network traffic is to be routed.

4. The system of claim 3, wherein causing the routing table to be updated comprises:
determining an updated local preference value based at least in part on the local preference value and the offset value; and
associating the updated local preference value with aggregated route information in connection with storing the aggregated route information in the routing table, the aggregated route information corresponding to the route information that the particular contributor node provided to the particular aggregator node.

5. The system of claim 4, wherein determining the updated local preference value comprises subtracting the offset value from the local preference value comprised in the local preference attribute of corresponding route information.

6. The system of claim 1, wherein:
first route information provided to a first aggregator node to be used as the primary aggregator node comprises a first offset value; and
second route information provided to a second aggregator node to be used as the backup aggregator node comprises a second offset value; and
the second offset value is greater than the first offset value.

7. The system of claim 6, wherein the first offset value is zero and the second offset value is non-zero.

8. The system of claim 1, wherein routing network traffic based at least in part on the routing table comprises:
selecting a selected aggregator node via which network traffic for a particular address is to be routed based at least in part on a local preference value stored in the routing table in association with the selected aggregator node.

9. The system of claim 8, wherein selecting the selected aggregator node comprises:
determining that the routing table stores a plurality of records for a particular network address, wherein at least two of the plurality of records are associated with different aggregator nodes;
determining a record from among the plurality of records having a highest local preference value; and
determining the selected aggregator node based at least in part on (i) an aggregator node identifier associated with the record, and (ii) a determination that a corresponding aggregator node is available to handle the network traffic.

10. The system of claim 9, wherein determining the selected aggregator node comprises:
determining that the aggregator node corresponding to the aggregator node identifier comprised in the record having the highest local preference is unavailable; and
determining the selected aggregator node to be a backup aggregator node for the particular address.

11. The system of claim 10, wherein the determining the selected aggregator node to be the backup aggregator node for the particular address comprises:
selecting another record from among the plurality of records, the other record having a next-highest local preference value from among the plurality of records; and
determining the selected aggregator node based at least in part on (i) an aggregator node identifier associated with the other record, and (ii) a determination that a corresponding aggregator node is available to handle the network traffic.

12. The system of claim 1, wherein the indication comprises an offset value encoded in a field of an extended community encoding.

13. The system of claim 1, wherein:
the indication comprises an offset value; and
the particular contributor node determines the offset value based at least in part on a determination of whether the particular aggregator node via which an advertised route is to be routed is to be used as the primary aggregator node or the backup aggregator node.

14. The system of claim 13, wherein the particular contributor node sets the offset value as zero in response to determining that the particular aggregator node is to be used as the primary aggregator node.

15. The system of claim 13, wherein the particular contributor node sets the offset value as non-zero in response to determining that the particular aggregator node is to be used as the backup aggregator node.

16. The system of claim 1, wherein:
the indication comprises an offset value; and
a Border Gateway Protocol (BGP) aggregate inherits from the route information obtained from the particular contributor node an updated local preference value determined based at least in part on (i) a local preference value encoded in the route information, and (ii) the offset encoded in the route information.

17. The system of claim 1, wherein:
the indication comprises an offset value; and
the offset value is used to lower a local preference value stored in a routing table record for the route information obtained from the particular contributor node.

18. The system of claim 1, wherein the particular aggregator node advertises the route information obtained from the particular contributor node to peer nodes in a network.

19. A method, comprising:
receiving, at least indirectly from one or more contributor nodes, a set of route information, wherein:
route information obtained from a particular contributor node comprises a network prefix, and one or more attributes; an
the one or more attributes comprises an indication of whether a particular aggregator node to which the route information is provided to be used as a primary aggregator node or a backup aggregator node;
causing a routing table to be updated based at least in part on the indication; and
routing network traffic based at least in part on the routing table.

20. A computer program product embodied in a non-transitory computer readable medium and comprising computer instructions for:
receiving, at least indirectly from one or more contributor nodes, a set of route information, wherein:
route information obtained from a particular contributor node comprises a network prefix, and one or more attributes; an
the one or more attributes comprises an indication of whether a particular aggregator node to which the route information is provided to be used as a primary aggregator node or a backup aggregator node;
causing a routing table to be updated based at least in part on the indication; and
routing network traffic based at least in part on the routing table.
